(19) United States
(12) Patent Application Publication
(10) Pub. No.: US 2009/0101380 A1
(43) Pub. Date: Apr. 23, 2009

(54) Portable Power Tool with Double Freewheel Drive Shaft Lock

(75) Inventor: Nabil Khalil Radif, Stockholm (SE)

Correspondence Address: FRISHAUF, HOLTZ, GOODMAN & CHICK, PC, 220 Fifth Avenue, 16TH Floor, NEW YORK, NY, 10001-7708, US

(73) Assignee: Atlas Copco Tools AB, Nacka (SE)

(21) Appl. No.: 12/227,049

(22) PCT Filed: May 7, 2007
(86) PCT No.: PCT/SE2007/000432

§ 371 Date: Dec. 5, 2008

(30) Foreign Application Priority Data
May 9, 2006 (SE) 0601026-8

(51) Int. Cl. B25F 5/00

(52) U.S. Cl. 173/213; 173/171

(57) ABSTRACT

A portable power tool with a rotation motor (11) drivingly connected to a working implement carrying chuck (16) via a drive shaft (13), wherein a rotation locking mechanism (19) is arranged to lock the drive shaft (13) in alternative directions via two freewheel couplings (21, 22), one “forward” rotation locking coupling (21) and one “reverse” rotation locking coupling (22). Both couplings (21, 22) are supported in an axially displaceable coupling sleeve (23) which is connected to an external maneuver ring element (24) on the outside of the housing (10) for shifting of the “forward” and “reverse” locking couplings (21, 22) between active and inactive positions, thereby accomplishing locking of the drive shaft (13) in either the “forward” direction or the “reverse” direction for loosening or tightening the chuck (16).

The invention relates to a portable power tool with a drive shaft connected at a driven end to a rotation motor and at a driving end to a working implement, wherein a manually operable lock means is provided to prevent rotation of the drive shaft at shifting of working implement.

In power tools of this type, for instance drilling machines, there is a need for locking the drive shaft against rotation during exchange of working tool, because the tool chuck is always opened and closed by a spanner, and for avoiding the need for two spanners, one extra for holding the drive shaft, there is employed a drive shaft lock means. In for instance power grinders there have been used a lock means of the pawl type wherein a manually operable pawl is brought into engagement with an abutment on or aperture in the drive shaft.

There is always a risk that a lock devices of this type is unintentionally activated during full speed rotation of the tool, but in power grinders that risk is very small due to a high operation speed. The lock pawl is unable to get into engagement with the drive shaft during the extremely short time interval the aperture in the drive shaft coincides with pawl. In low speed tools, however, like drilling machines with a rotation speed of typically 1/10 of the speed of a power grinder, a locking pawl might enter an aperture in the drive shaft and cause a very abrupt and self-destructive stop to the rotating parts of the tool and also a dangerous energy transfer to the tool housing and the operator.

In the previously used pawl type drive shaft lock means there is required at least one aperture to be provided in the drive shaft which means a weakening of the drive shaft, especially in smaller size tools having small diameter drive shafts.

The main object of the invention is to create a portable power tool with a rotating drive shaft where a two-way locking of the drive shaft is accomplished with a reduced risk for unintentional activation of the lock means and without any weakening of the drive shaft.

Further characteristic features and advantages of the invention will appear from the following specification and claims.

A preferred embodiment of the invention is described below with references to the accompanying drawing.

In the drawings

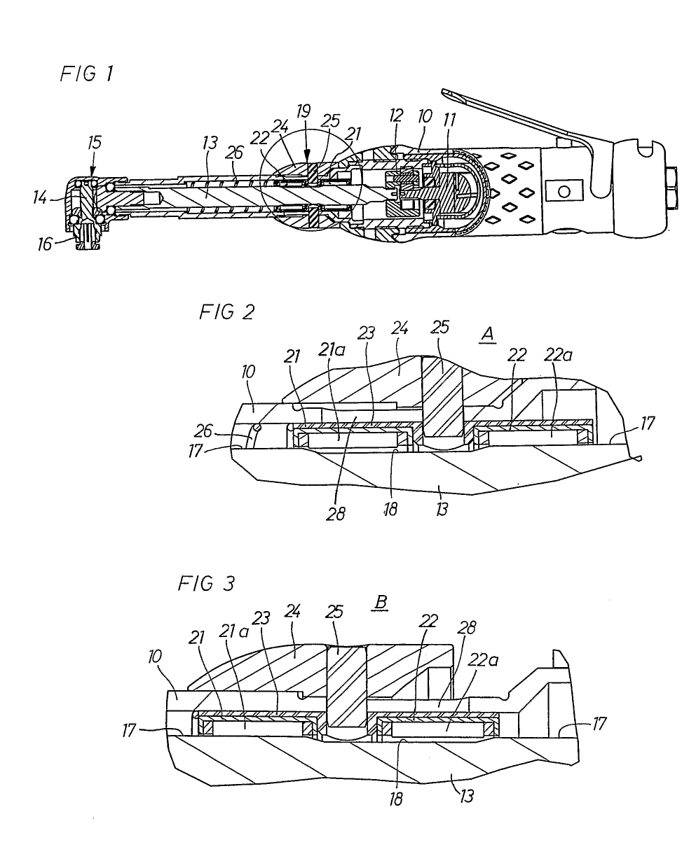

FIG. 1 shows a longitudinal section through a power tool according to the invention.

FIG. 2 shows, on a larger scale, a fractional view of the drive shaft locking mechanism of the power tool in FIG. 1, illustrating a first locking position.

FIG. 3 shows the locking mechanism in FIG. 2, but illustrating a second locking position.

The power tool illustrated in the drawing figures is a pneumatic drilling tool which comprises a housing 10, a rotation motor 11, a reduction gearing 12, a drive shaft 13, an angle head 15, and an output shaft 14 supported in the angle head 15 and carrying a chuck 16 for attachment of a working implement. The drive shaft 13 extends between the reduction gearing 12 and the angle head 15 and has a cylindrical envelope surface 17 for engagement with a rotation locking mechanism 19 and a waist portion 18.

A rotation locking mechanism 19 comprises a two freewheel couplings 21, 22 arranged to lock the drive shaft 13 in opposite directions of rotation. The freewheel couplings consist of a “forward” locking coupling 21 and a “reverse” locking coupling 22, whereof the “forward” locking coupling 21 is able to lock the drive shaft 13 in the normal operating forward direction, whereas the “reverse” locking coupling 22 is able to lock the drive shaft 13 in the reverse direction.

Both drive shaft locking couplings 21, 22 are supported in a surrounding coupling sleeve 23 which is locked against rotation but axially displaceable in the housing 10 for shifting of the freewheel couplings 21, 22 between active and inactive conditions. Each one of the freewheel couplings 21, 22 comprises a number of lock elements 21a, 22a arranged to co-operate with the envelope surface 17 of the drive shaft 13 and the coupling sleeve 23. A ring element 24 is guidingly supported on the housing 10 for displacement between a first position A and a second position B. The ring element 24 is connected to the coupling sleeve 23 via a number of radial pins 25 extending through slots 28 in the housing 10. The ring element 24 is arranged to bring along the sleeve 23 when being displaced between the first and second positions A, B to thereby shift the locking mechanism 19 between a “forward” locking condition and a “reverse” locking condition. The radial pins 25 are movably guided in the axially extending slots 28 and serve as a rotation lock means for the coupling sleeve 23 and the maneuver ring 24. A spring 26 exerts a bias force on the coupling sleeve 23 towards the first position A in which the “reverse” rotation locking freewheel 22 is in its active position.

The operating conditions of the drive shaft 13 locking mechanism 19 illustrated in FIGS. 1 and 2 are: the “reverse” rotation locking position, wherein the drive shaft 13 is locked against reverse rotation and a “forward” rotation locking position, wherein the drive shaft 13 is locked against “forward” rotation. In the “reverse” position the freewheel 22 occupies its active position in which the lock elements 22a engage both the coupling sleeve 23 and the envelope surface 17 of the drive shaft 13. In this position of the coupling sleeve 23 the “forward” locking freewheel 21 occupies its inactive position wherein the lock elements 21a are located in alignment with the waist portion 18 of the drive shaft 13. This means that the lock elements 21a are out of engagement with the drive shaft 13 and unable to prevent rotation of the latter.

In the active condition of the “reverse” rotation locking freewheel 22 the output shaft 14 and the chuck 16 are locked against reverse rotation, which means that the chuck 16 may be easily be loosened by means of a spanner and the attached working implement may be removed.

When moving the maneuver ring 24 and the coupling sleeve 23 to the second position B, as illustrated in FIG. 3, the “forward” locking coupling 21 is brought out of alignment with the waist portion 18 and is slid onto the envelope surface 17 of the drive shaft 13, whereas the “reverse” locking coupling 22 is brought into alignment with the waist portion 18. This means that the “reverse” locking coupling 22 is deactivated, whereas the “forward” locking coupling 21 is activated with its lock elements 21a engaging the drive shaft surface 17 to lock the drive shaft 13 against forward rotation. In these positions of the couplings 21, 22 the chuck 16 is locked against “forward” rotation and may be tightened to retain a fitted working implement.

1-5. (canceled)

6. A portable power tool comprising:
a housing,
a rotation motor,
a drive shaft connected at a driven end thereof to the motor and at a driving end thereof to a working implement carrying chuck, and
a manually operable locking device for locking the drive shaft against rotation at loosening and tightening of the chuck,
wherein said locking device comprises:
a “forward” locking freewheel coupling and a “reverse” locking freewheel coupling, and
a maneuver device arranged on the housing for movement between:
a first position in which said “reverse” locking freewheel coupling occupies an active position and said “forward” locking freewheel coupling occupies an inactive position, and
a second position in which said “forward” locking freewheel coupling occupies an activate position and said “reverse” locking freewheel coupling occupies an inactive position,
wherein a spring is arranged to bias said maneuver device towards said first position.

7. The power tool according to claim 6, wherein:
both said “forward” and “reverse” locking freewheel couplings are arranged to engage an envelope surface of the drive shaft in their active positions, and
said drive shaft includes a waist portion, and
wherein said “forward” and “reverse” locking freewheel couplings are in alignment with said waist portion as they occupy their inactive positions.

8. The power tool according to claim 7, wherein:
said “forward” and “reverse” locking freewheel couplings are supported in a common coupling sleeve which is rotationally locked but axially displaceable relative to the housing, and
said maneuver device comprises a ring element guidingly supported on an outside of the housing and connected to said coupling sleeve via slots in the housing.

9. The power tool according to claim 6, wherein both of said “forward” and “reverse” locking freewheel couplings comprise a number of lock elements for engagement with both of said coupling sleeve and a drive shaft envelope surface, all of said lock elements having an axial extent that is less than the axial extent of a waist portion of said drive shaft.

10. The power tool according to claim 7, wherein both of said “forward” and “reverse” locking freewheel couplings comprise a number of lock elements for engagement with both of said coupling sleeve and said drive shaft envelope surface, all of said lock elements having an axial extent that is less than the axial extent of said waist portion.

11. The power tool according to claim 8, wherein both of said “forward” and “reverse” locking freewheel couplings comprise a number of lock elements for engagement with both of said coupling sleeve and said drive shaft envelope surface, all of said lock elements having an axial extent that is less than the axial extent of said waist portion.

12. The power tool according to claim 6, wherein said drive shaft is connected to the working implement carrying chuck via an angle head.

13. The power tool according to claim 7, wherein said drive shaft is connected to the working implement carrying chuck via an angle head.

14. The power tool according to claim 8, wherein said drive shaft is connected to the working implement carrying chuck via an angle head.

15. The power tool according to claim 9, wherein said drive shaft is connected to the working implement carrying chuck via an angle head.

16. The power tool according to claim 10, wherein said drive shaft is connected to the working implement carrying chuck via an angle head.

17. The power tool according to claim 11, wherein said drive shaft is connected to the working implement carrying chuck via an angle head.
